(19) United States
(12) Patent Application Publication
(10) Pub. No.: US 2021/0034999 A1
(43) Pub. Date: Feb. 4, 2021

(54) OPTIMIZATION DEVICE, OPTIMIZATION METHOD, AND OPTIMIZATION PROGRAM

(71) Applicant: NEC CORPORATION, Tokyo (JP)

(72) Inventor: Akihiro YABE, Tokyo (JP)

(73) Assignee: NEC CORPORATION, Tokyo (JP)

(21) Appl. No.: 16/966,715

(22) PCT Filed: Feb. 2, 2018
(86) PCT No.: PCT/JP2018/003681

§ 371 Date: Jul. 31, 2020

(51) Int. Cl. G06N 7/00; G06N 5/02

(52) U.S. Cl. CPC G06N 7/005; G06N 5/02

(57) ABSTRACT

In an optimization device 80, an explanatory variable used for explanation of a prediction target becomes an instrumental variable for optimization, and the optimization is performed on the basis of a prediction of the prediction target. A candidate set determination unit 81 determines a set of candidates for a predicted instrumental variable. For instrumental variables included in the set, a margin determination unit 82 determines a margin including an estimation error, which is an error due to the prediction, with a designated probability. A robust optimization unit 83 performs robust optimization related to the instrumental variables by using the determined margin.

### TECHNICAL FIELD

The present invention relates to an optimization device, an optimization method, and an optimization program that perform optimization on the basis of a prediction.

### BACKGROUND ART

Recently, a device or system that provides a user with optimal information under a predetermined condition (such as input amount of material in plant, operation amount in operation device, or set price of item) on the basis of many pieces of information is used. Also, a device or system that provides information for the user to make a final selection (such as determination index or the like) is also used.

For example, in control of an electrical generating system including a plurality of power plants, an electric power company needs to determine a power generation amount of each power plant which amount satisfies a predetermined condition (such as minimizing cost while satisfying total demand power). Thus, for example, an optimization model in which an electrical generating system based on a demand prediction (prediction of total demand power) is modeled is created in an electric power company. Then, in order to determine an optimal power generation amount (optimal solution), an optimal solution (power generation amount) in the optimization model is calculated by utilization of a predetermined device or system.

In addition, when purchasing a material in a production activity, a purchase department of a company needs to determine a purchase amount (optimal solution) of the material with which amount a profit is maximized (purchase cost is minimized) while a production plan and the like are satisfied. Thus, the purchase department creates an optimization model in which a purchase amount based on a demand prediction (such as prediction of required amount of material) is modeled. Then, in order to determine the purchase amount, an optimal solution (purchase amount) in the created optimization model is calculated by utilization of a predetermined device or system.

A detailed example of a technology in which software or a predetermined device optimally makes determination or a plan based on a prediction as described above will be described below.

First, an optimization model that is a target of optimization processing is determined. The optimization model includes an “objective function” indicating a specific objective of optimization, and a “constraint” that is a condition in calculation of an optimal solution. The “objective function” is expressed as a function of an “instrumental variable”. The “instrumental variable” is a target of optimization. In the optimization, the above software or device optimizes a value of the “instrumental variable” in such a manner that a value of the objective function becomes optimal (for example, maximum or minimum) while a constraint is satisfied. The optimized value of the objective variable is hereinafter referred to as an “optimal solution”. Note that the optimal solution is a future value. Thus, the objective function includes therein a prediction model expressed by utilization of a predetermined variable and parameter.

The prediction model is a model indicating a relationship between a variable that is a prediction target (hereinafter, referred to as “explained variable”) and a variable that may influence the prediction target (hereinafter, referred to as “explanatory variable”). Generally, the explained variable is expressed as a function using the explanatory variable in the prediction model.

As described above, a term “explained variable” is used for a variable that is a prediction target in a prediction. On the other hand, a term “instrumental variable” is used for a variable that is an optimization target in optimization processing. In such a manner, the term “explained variable” and the term “instrumental variable” are used separately in the following description.

Note that the prediction model is created on the basis of machine learning using a past explanatory variable and explained variable, for example. A general method for generating a prediction model is, for example, a “regression analysis”.

Then, the information processing device calculates, as an optimal solution of the optimization model, a value of an objective variable that optimizes (for example, maximize) an objective function (optimal solution). Here, at least a part of explanatory variables in the prediction model may be an objective variable in the optimization model (variable that is target of optimization). This point will be described later by utilization of a detailed example of price optimization.

Also, generally, an objective variable has a limit in a range of possible values. For example, there is an upper limit to a power generation amount at the above power plants. For example, such a limitation is an example of the “constraint”. However, the constraint may include a different condition. Thus, for example, the information processing device calculates an optimal solution that maximizes a value of an objective function within a range that satisfies a predetermined constraint. In such a manner, the optimization model used as an optimization target by an information processing device that calculates an optimal solution is a model including an objective function and a constraint.

Note that since the optimization model is processed in the information processing device, the above objective function and constraint are generally expressed by utilization of a form that can be handled by the information processing device (generally, mathematical expression expressed with variable). Then, the information processing device calculates, as an optimal solution, a value of an objective variable having a value of the objective function as an optimal value (maximum value or minimum value) under a constraint included in the optimization model.

In a case where the objective function included in the optimization model is expressed by utilization of a linear function of the objective variable, the optimization model is called a “linear optimization model”. Also, in a case where the objective function included in the optimization model is expressed by utilization of a quadratic function of the objective variable, the optimization model is called a “quadratic optimization model”.

Here, as a detailed example, an optimization model for price optimization indicating how much each item or service shall be set in order to optimize the total sales amount of a plurality of certain items or services will be described. However, an item is used as an example in the following description.

The total sales amount is the sum of the product of a price of each item and a sales volume (number of sales) of the item. That is, the total sales amount is a “total sales amount=the sum of (price of each item×sales volume of each item)”.

Here, a price of an item is a value that can be set by a seller of the item. On the other hand, a sales volume is a value that cannot be determined by the seller and is a future value when seen from a time point at which the optimization processing is executed.

Thus, in order to predict a sales volume of an item, for example, a prediction model is set by utilization of machine learning. Here, it is obvious that the sales volume of the item is affected by a price of the item. Thus, the sales volume of the item is an explained variable in the prediction model of predicting the sales volume of the item. Also, a price of the item is an explanatory variable in the prediction model. That is, the sales volume of the item which volume is the explained variable is expressed as a function of the price of the item in the prediction model. That is, the total sales amount (objective function) is the product of the “explanatory variable (price of item)” and the “explained variable (sales volume affected by price of item)”.

As described above, the explained variable is expressed by utilization of the function of the explanatory variable (price of item). Thus, the total sales amount (objective function) is at least a quadratic function of the price of the item (explanatory variable).

Here, the price of the item is an objective variable in the optimization model. That is, the total sales amount (objective function) is expressed by utilization of at least a quadratic function of the objective variable (price of item). Thus, in a case where the total sales amount is optimized by manipulation of the price of the item as described above, a quadratic optimization model is used as the optimization model. Note that in this case, a constraint is an inventory level of the item, for example.

Note that the explanatory variable (price of item) in the prediction model can be an objective variable (price of item) in the optimization model, that is, a variable to be optimized, as understood from the above detailed example. In other words, note that one variable that is a price of an item behaves as an explanatory variable in the learning processing and the prediction processing and behaves as an objective variable in the optimization processing.

The optimization model includes one or a plurality of parameters in a mathematical expression expressing the optimization model. The parameter is a value determined on the basis of past observation data and the like. However, the observation data is data including an error in measurement. Also, a calculation target of the optimization model is a future value (optimal solution) that is not yet fixed. That is, there is a possibility that the optimal solution is calculated in a situation different from that in generation of past data. Thus, a parameter included in the optimization model includes uncertainty.

A method of calculating an optimal solution in an optimization model widely used in general does not consider the uncertainty in a parameter. Thus, there is a possibility that an optimal solution calculated by utilization of a general optimization model is not optimal when actually applied. A reason for this will be described in the following.

As mentioned above, an optimization model includes a parameter. Here, the parameter has uncertainty. Thus, there is a case where a value of the parameter in actual application of a value of an optimal solution is different from a value of the parameter used to calculate the optimal solution. In this case, there is a possibility that the calculated optimal solution is not an optimal solution in actual application.

Thus, a robust optimization model is proposed as one of optimization models considering uncertainty of a parameter (see, for example, NPL 1). The robust optimization model sets a predetermined range of uncertainty (such as elliptical region in parameter space) for a parameter. Then, an information processing device that calculates an optimal solution in the robust optimization model calculates an optimal solution in the range of uncertainty.

In a case where a value of a parameter in application of an optimal solution is within the assumed range of uncertainty of the parameter, the optimal solution calculated by utilization of the robust optimization model can guarantee correctness of the solution when applied. The above optimization model in which the robust optimization model is applied to the linear optimization model is called a robust linear optimization model. Also, an optimization model in which the robust optimization model is applied to a quadratic optimization model is called a robust quadratic optimization model.

### CITATION LIST

### Non Patent Literature

NPL 1:Dimitris Bertsimas, David B. Brown, and Constantine Caramanis, “Theory and Application of Robust Optimization”, Society for Industrial and Applied Mathematics (SIAM)

### SUMMARY OF INVENTION

### Technical Problem

Two kinds of uncertainty in a parameter are assumed. One is a “prediction error” that is noise included in an input of optimization. The other is a “system error” that is noise expected after the optimization is over. The “System error” indicates uncertainty of a system itself. The “prediction error” indicates a variation generated in estimation itself due to past data being affected by a system error in estimation (expression) of the system from the past data.

Robust optimization requires determination how much uncertainty is assumed. Hereinafter, this degree of uncertainty will be referred to as a margin. The margin needs to be set to the extent that there is no excess or deficiency with respect to a required guarantee level (such as stockout probability being 10%). This is because a guarantee cannot be satisfied when assumed uncertainty is too small while a cost becomes enormous when uncertainty larger than the level is assumed. That is, an excessively conservative strategy is as unrealistic as a strategy that does not satisfy the guarantee. Also, it is preferable that this level can be automatically determined from data.

Generally, this level (margin) is automatically determined on the basis of “uncertainty of estimation” of a parameter. More specifically, a method of assuming a parameter included in an uncertainty region U at a guarantee level α, and performing robust optimization on the assumption of the worst case in the uncertainty region U is known.

However, a size of the uncertainty region U determined in such a manner (amount corresponding to radius in circle) is increased as a dimension of a parameter is increased. This is because it is necessary to increase assumed uncertainty (≈radius) for each parameter in order to guarantee uncertainty of more parameters. However, it is empirically known that robust optimization using such an uncertainty region U becomes excessively conservative.

A typical example of being such excessively conservative will be described. It is assumed that estimation parameters include a dummy parameter (that is, parameter not related to optimization at all). Here, when the above-described guarantee is assumed, a size of the uncertainty region U is determined on the basis of a dimension including the dummy parameter. There is a problem that although the dummy parameter is originally unnecessary, an excessive guarantee is required for an increase in size due to this.

Thus, the present invention is to provide an optimization device, an optimization method, and an optimization program that can control an excessive guarantee and calculate an optimal solution in a case where an optimization parameter having uncertainty is given on the basis of a prediction.

### Solution to Problem

An optimization device according to the present invention is an optimization device in which an explanatory variable used for explanation of a prediction target becomes an instrumental variable for optimization and which performs the optimization on the basis of a prediction of the prediction target, the device including: a candidate set determination unit that determines a set of candidates for a predicted instrumental variable; a margin determination unit that determines a margin including an estimation error, which is an error due to the prediction, with a designated probability with respect to instrumental variables included in the set; and a robust optimization unit that performs robust optimization related to the instrumental variables by using the determined margin.

An optimization method according to the present invention is an optimization method in which an explanatory variable used for explanation of a prediction target becomes an instrumental variable for optimization and which performs the optimization on the basis of a prediction of the prediction target, the method including: determining a set of candidates for a predicted instrumental variable; determining a margin including an estimation error, which is an error due to the prediction, with a designated probability with respect to instrumental variables included in the set; and performing robust optimization related to the instrumental variables by using the determined margin.

An optimization program according to the present invention is an optimization program applied to a computer in which an explanatory variable used for explanation of a prediction target becomes an instrumental variable for optimization and which performs the optimization on the basis of a prediction of the prediction target, the program causing the computer to execute candidate set determination processing of determining a set of candidates for a predicted instrumental variable, margin determination processing of determining a margin including an estimation error, which is an error due to the prediction, with a designated probability with respect to instrumental variables included in the set, and robust optimization processing of performing robust optimization related to the instrumental variables by using the determined margin.

### Advantageous Effects of Invention

According to the present invention, it is possible to control an excessive guarantee and to calculate an optimal solution in a case where an optimization parameter having uncertainty is given on the basis of a prediction.

### BRIEF DESCRIPTION OF DRAWINGS

FIG. 1 It depicts a block diagram illustrating an exemplary embodiment of an optimization device according to the present invention.

FIG. 2 It depicts a flowchart illustrating an operation example of the optimization device.

FIG. 3 It depicts a block diagram illustrating an outline of the optimization device according to the present invention.

FIG. 4 It depicts a schematic block diagram illustrating a configuration of a computer according to at least one exemplary embodiment.

### DESCRIPTION OF EMBODIMENTS

First, problem setting assumed in the present invention will be described with a detailed example.

It is assumed that X is a domain of an instrumental variable and is a subset of an m-dimensional vector space. Also, an element of X is expressed as x. Here, an optimization model with respect to a realized value θ of a parameter is defined as in Expression 1 exemplified in the following.

min f₀(x)

s.t. fₖ(x, θ)≤0 (Expression 1)

In Expression 1, θ is a realized parameter in the future. Also, it is assumed that fₖ is linear with respect to θ. For example, a portfolio optimization problem requires maximization of an expected payoff r. Thus, the portfolio optimization problem can be defined as in Expression 2 exemplified in the following.

max r

s.t. r≤θ^{T}x0≤Σx≤C (Expression 2)

In Expression 2, θ is a vector, and an i-th element of θ is a payoff acquired as a result of investing in an asset i. xᵢ expresses an amount of money invested in an asset i. Also, C is an amount of total assets. In other words, the problem expressed in Expression 2 in the above can be said as a problem of allocating limited assets and maximizing an investment effect.

Also, for example, in an inventory cost optimization problem, it is required to minimize an inventory cost. Thus, an inventory cost minimization problem can be defined as in Expression 3 exemplified in the following.

min Σcᵢxᵢ

s.t. xᵢ≥θᵢ (Expression 3)

In Expression 3, cᵢ is an inventory cost per item i, xᵢ is an inventory level of the item i, and θᵢ is a demand for the item i.

In addition, many problems such as power generation optimization based on a power demand parameter, and plant design optimization based on an item demand parameter are formulated as in Expression 1 to 3 described above.

In practice, θ described above cannot be used to determine a strategy x. This is because θ is a value found in the future in which x is determined. Thus, an average value θ* of θ is predicted, and θ hat (θ with superscript ^{∧}; hereinafter referred to as θ^{∧}) is acquired as the predicted value. It is necessary to perform optimization on the basis of θ^{∧}. In the following, this processing will be described.

First, it is assumed that a future value θ is determined by θ to θ*−θₛ. Here, θₛ is a random variable indicating a system error, and an average thereof is 0. As described above, the system error is an unpredictable value.

Next, θ* is estimated on the basis of a prediction engine by utilization of past data. In a case of an invariant estimator, the estimate value θ^{∧} can be described as θ^{∧} to θ* −θₑ. Here, θₑ is a random variable indicating the estimation error, and an average thereof is 0. This indicates that the estimate value θ^{∧} also becomes an uncertain value including the estimation error θₑ due to statistical uncertainty of the past data.

A process of prediction optimization includes the following three steps.

Step 1: Acquire a realized value θ tilde (θ with superscript ˜; hereinafter referred to as θ˜) of θ^{∧}. It can be said that θ^{˜} is an estimate value.

Step 2: Perform optimization on the basis of θ˜.

Step 3: Calculate a payoff on the basis of a realized value of θ.

Note that θ^{∧} in Step 1 is a random variable indicating an estimate value, and only the one realized value is acquired in reality.

Here, in Step 2, neither a true value θ* nor a future realized value of θ can be known. However, it is possible to acquire “how likely θ˜ is deviated from θ*” although it is not possible to acquire “how much θ˜is deviated from θ*”. For example, by estimating a variance-covariance matrix of θ^{∧} or approximating samples of θₛ and θₑ by bootstrap sampling, it is possible to acquire “how likely θ˜ is deviated from θ*”.

On the other hand, in Step 2, when θ is simply replaced with an estimate value and optimization is performed as in Expression 4 exemplified in the following, a constraint cannot be satisfied with a high probability. Note that K is an index of a constraint condition expression.

min f₀(x)

s.t. fₖ(x, θ˜)≤0, k=1, 2, . . . , K (Expression 4)

Thus, it is necessary to set an appropriate margin gₖ(x)≥0 and perform optimization as in Expression 5 exemplified in the following.

min f₀(x)

s.t. fₖ(x, θ˜)+gₖ(x)≤0, k=1, 2, . . . , K (Expression 5)

Such an optimization method is called robust optimization. In a method of setting the margin gₖ(x), when a guarantee level α is given, a region U is set in such a manner that Expression 6 exemplified in the following is satisfied.

Prob(θₛ+θₑ∈U)≥α (Expression 6)

Here, when gₖ is defined as in Expression 7 exemplified in the following, a solution acquired for this margin gₖ(x) satisfies a constraint on the future realized value θ with a probability α or more.

gₖ(x)=max_{{u∈U}}f(x, u) (Expression 7)

However, for example, when the number of dummy estimation parameters is increased, a size of the region U set in such a manner is increased, and a value of gₖ is also increased. As a result, an excessively-guaranteed strategy is selected. This is because, with gₖ defined in such a manner, a constraint value including a margin is equal to or larger than a true realized value for any strategy x with a probability α. That is, this is to satisfy Expression 8 exemplified in the following.

∀x∈X, f(x, θ)≤fₖ(x, θ˜)+gₖ(x) (Expression 8)

However, the inventor of the present application has found that an inequality in Expression 8 described above actually does not need to hold for all x and that it is sufficient when the inequality holds for x that becomes a candidate for a solution. More specifically, the inventor has found, from the above-described example of the dummy parameter, that it is necessary to measure an “essential dimension” of a parameter and to assume uncertainty corresponding thereto.

Thus, in the present invention, this essential dimension is measured by measurement of a size of an optimization domain, that is, “uncertainty of optimization”. That is, by measuring the “uncertainty of optimization” in addition to “uncertainty of estimation”, it becomes possible to perform optimization based on an uncertainty level without excess or deficiency.

In the following, exemplary embodiments of the present invention will be described with reference to the drawings.

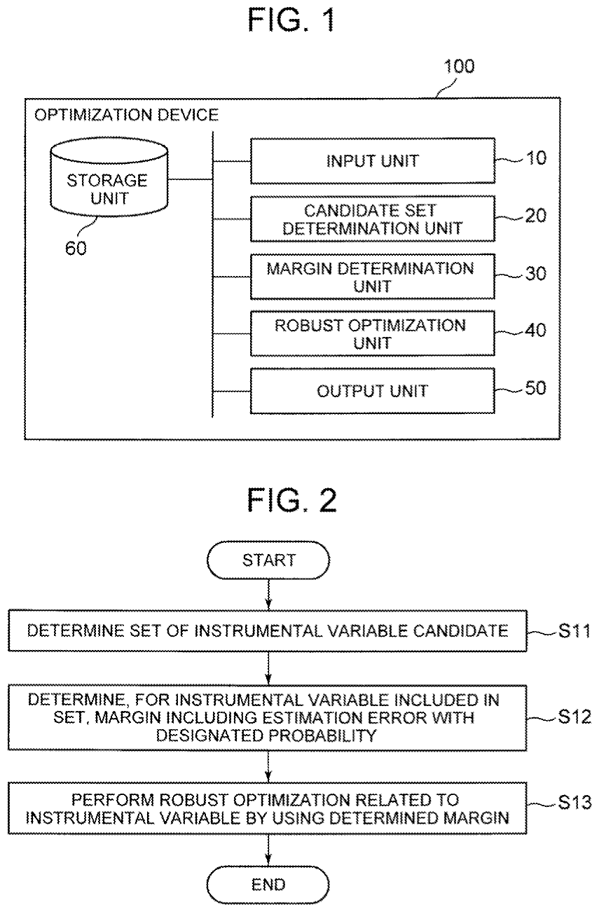

FIG. 1 is a block diagram illustrating an exemplary embodiment of an optimization device according to the present invention. In an optimization device 100 of the present exemplary embodiment, an explanatory variable used for explanation of a prediction target becomes an instrumental variable for optimization, and the optimization is performed on the basis of a prediction of the prediction target.

The optimization device 100 of the present exemplary embodiment includes an input unit 10, a candidate set determination unit 20, a margin determination unit 30, a robust optimization unit 40, an output unit 50, and a storage unit 60.

The storage unit 60 is realized, for example, by a magnetic disk or the like, and stores input information, information in the middle of processing, information about a processing result, and the like. Also, the storage unit 60 stores a set of candidates for a margin which set is used when the margin determination unit 30 (described later) determines a margin.

The input unit 10 inputs information used in processing (described later) by the candidate set determination unit 20, the margin determination unit 30, and the robust optimization unit 40. More specifically, the input unit 10 inputs a prediction expression (prediction model) used for a prediction, and an estimation error. For example, the input unit 10 may input, as a prediction parameter, a parameter expressing the prediction model. Also, for example, the input unit 10 may input, as the estimation error, a prediction error distribution expressed by a variance-covariance matrix Σ. Also, the input unit 10 inputs a guarantee probability α. The guarantee probability α is designated and input by a user, for example.

The candidate set determination unit 20 determines a set of instrumental variable candidates (hereinafter, also referred to as domain). A method with which the candidate set determination unit 20 determines the domain is arbitrary. The candidate set determination unit 20 may determine a set X of instrumental variables x corresponding to a solution, for example, according to uncertainty of an estimation error θₑ. Also, the candidate set determination unit 20 may determine the set X, for example, by extracting only constraints that do not have uncertainty. A constraint that does not have uncertainty does not include an uncertain parameter, and can be distinguished from a constraint that has uncertainty.

For example, in a case of a price optimization problem, a constraint that “a price is between a list price and a price discounted by 50 percent” is a constraint that does not have uncertainty. Also, for example, in a case of an inventory optimization problem, constraints that “an inventory level is non-negative” and “an inventory investment amount is within a budget” are constraints that do not have uncertainty. On the other hand, a constraint that “an inventory level exceeds a demand with a high probability” is a constraint that has uncertainty because the demand has uncertainty.

A detailed example in which the candidate set determination unit 20 determines a set X will be described. For example, θₛ+θₑ is sampled, and θ˜+θₛ+θₑ is set as a candidate for a future realized value. Here, the candidate set determination unit 20 may approximate the set X by a finite sample by repeatedly solving Expression 9 exemplified in the following.

min f₀(x)

s.t. fₖ(x, θ˜+θₛ+θₑ)≤0, k=1, 2, . . . , K (Expression 9)

In addition, for example, a region T that satisfies Prob(θₛ+θₑ∈T)≥1−δ is defined. Note that 1−δ is a probability criterion and is a probability including a true optimal solution in a case where a range of the set X is limited. δ is designated by a user, for example. Here, the candidate set determination unit 20 may approximate the set X by approximating the region T by a plurality of samples and solving, with respect to the samples t, Expression 10 exemplified in the following.

min f₀(x)

s.t. fₖ(x, θ˜+t)≤0, k=1, 2, . . . , K (Expression 10)

The margin determination unit 30 determines, with respect to instrumental variables included in the set determined by the candidate set determination unit 20, a margin including an estimation error with a designated probability α. More specifically, the margin determination unit 30 calculates, with respect to all instrumental variable candidates (solution candidate) x included in the determined set, a margin with which a constraint expression with the margin including an estimation error becomes an upper bound of a true constraint expression. Here, when the true constraint expression is fₖ(x, θ˜) and the margin is gₖ(x), the constraint expression with a margin can be expressed as fₖ(x, θ˜+θₑ)+gₖ(x). This is equivalent to fₖ(x, −θₑ)+gₖ(x)≥0 from linearity of f. Thus, in a case where a system error is not assumed, the margin determination unit 30 calculates a minimum margin g that satisfies Expression 11 exemplified in the following.

[Math 1]

Prob_{θ}_{ₑ}(min_{x∈X}fₖ(x, −θₑ)+g_{(k,r)}(x)≥0, k=1,2, . . . , K)≥α (Expression 11)

Note that in the present exemplary embodiment, a margin candidate set Gᵣ=(g_{{1,r}}, . . . , g_{{K, r}}) is defined. The margin candidate set Gᵣ includes, for example, margin candidates parameterized by a one-dimensional parameter r≥0. For example, in a case where there is one uncertain constraint, Gᵣ includes one function. Here, in a case where Gᵣ=(rg(x)) is defined on the basis of a certain non-negative function g(x), this becomes a margin. Generally, when there are K uncertain constraints, a margin is defined as Gᵣ=(rg₁, rg₂, . . . , rg_{K}) on the basis of “unit margins” g₁, g₂, . . . , g_{K} related to each constraint. The margin determination unit 30 determines, for all of explanatory variable candidates x included in the determined set, a minimum margin G{_{r*}} in such a manner that a constraint expression with a margin including an estimation error with a probability α becomes stricter than a true constraint expression.

Also, the margin determination unit 30 may consider the above-described probability criterion (probability of including true optimal solution in case where range of set is limited) when determining the margin. That is, in a case where the candidate set determination unit 20 limits the set X of solution candidates by a probability criterion of 1−δ, the margin determination unit 30 may replace the probability α with α+δ and determine the margin.

More specifically, since θₑ can be sampled, the margin determination unit 30 calculates, for θ_{{e, i}}i=1, . . . , I, minimum r with which αS samples thereamong satisfy Expression 12 exemplified in the following. More specifically, since S is an integer and α is a real number from 0 to 1, the margin determination unit 30 determines minimum r with which samples, the number of which is acquired by rounding up of αS, satisfy Expression 12 exemplified in the following.

min_{{x∈X}}fₖ(x, −θ_{{e, i}})+g{k, r}(x)≥0k=1, 2, . . . , K (Expression 12)

Since X is approximated by the finite number of points for each r, Expression 12 in the above can be determined only by calculation of a function f and a function g.

Moreover, in a case where the system error θₛ is considered, Expression 11 in the above can be replaced with Expression 13 exemplified in the following.

[Math 2]

∫dθₑmin_{{x∈X}}Prob_{θ}_{ₛ}(fₖ(x, −θₑ−θₛ)+g_{{k,r}}(x)≥0, k=1, 2, . . . , K|θₑ)≥α (Expression 13)

In Expression 13, a probability Prob_{{θs}} with respect to −θₛ can be approximated by acquisition of a finite sample of θₛ, and a probability integral ∫dθₑ can be similarly approximated by a sample. Thus, it is possible to determine whether Expression 13 in the above holds for each r. For example, by a binary search, the margin determination unit 30 may determine minimum r (minimum margin) that satisfies a condition.

The robust optimization unit 40 performs robust optimization related to the instrumental variables by using the determined margin. That is, the robust optimization unit 40 performs robust optimization by solving the optimization problem with a margin by using the determined margin g.

A method by which the robust optimization unit 40 performs the robust optimization is arbitrary. The robust optimization unit 40 may perform the robust optimization by using a generally known method. Since a method of performing the robust optimization is widely known, a detailed description thereof is omitted here.

Note that there is also a case where an acquired solution is not included in the set X in a case of the present exemplary embodiment although it is assumed that the set X, which is an assumed candidate, includes an optimal solution. Here, the robust optimization unit 40 may approximate an optimal solution to a value closest to an acquired solution in the set X. Also, the robust optimization unit 40 may correct an optimal solution by resetting an additional margin and performing optimization. Note that the robust optimization unit 40 may adopt, as an optimal solution, a solution acquired without correction.

The candidate set determination unit 20, the margin determination unit 30, and the robust optimization unit 40 are realized by a processor (such as central processing unit (CPU), graphics processing unit (GPU), or field-programmable gate array (FPGA) of a computer that operates according to a program (optimization program).

For example, the program may be stored in a storage unit (not illustrated), and the processor may read the program and operate as the candidate set determination unit 20, the margin determination unit 30, and the robust optimization unit 40 according to the program. Also, a function of an optimization device may be provided in a form of software as a service (SaaS).

Each of the candidate set determination unit 20, the margin determination unit 30, and the robust optimization unit 40 may be realized by dedicated hardware. Also, a part or whole of each component of each device may be realized by general-purpose or dedicated circuitry, processor, or the like or a combination thereof. These may include a single chip or may include a plurality of chips connected through a bus. A part or whole of each component of each device may be realized by a combination of the above-described circuitry or the like, and the program.

Also, in a case where a part or whole of each component of the optimization device is realized by a plurality of information processing devices, circuitry, and the like, the plurality of information processing devices, circuitry, and the like may be collectively arranged or dispersedly arranged. For example, the information processing devices, circuitry, and the like may be realized in a form of being connected through a communication network, the form being a client server system or a cloud computing system, for example.

Next, an operation of the optimization device of the present exemplary embodiment will be described. FIG. 2 is a flowchart illustrating an operation example of the optimization device of the present exemplary embodiment.

The candidate set determination unit 20 determines a set X of instrumental variable candidates (Step S11). The margin determination unit 30 determines, for the instrumental variables included in the set X, a margin including an estimation error with a designated probability a (Step S12). Then, the robust optimization unit 40 performs robust optimization related to the instrumental variables by using the determined margin (Step S13).

As described above, in the present exemplary embodiment, the candidate set determination unit 20 determines an instrumental variable candidate set, and the margin determination unit 30 determines, for instrumental variables included in the set, a margin including an estimation error with a designated probability. Then, the robust optimization unit 40 performs robust optimization related to the instrumental variables by using the determined margin. Thus, in a case where an optimization parameter having uncertainty is given on the basis of a prediction, it is possible to calculate an optimal solution while controlling an excessive guarantee.

In such a manner, the optimization device of the present exemplary embodiment can reduce a computational cost of when robust optimization that satisfies a required guarantee level is performed. In other words, the optimization device of the present exemplary embodiment makes it possible to significantly control the computational cost of the robust optimization by a computer.

Next, an optimization problem of the present exemplary embodiment will be described with an inventory optimization problem as an example. Here, an inventory optimization problem of 100 items which problem is exemplified in Expression 14 in the following is assumed. It is assumed that a demand is generated in a normal distribution, and θ*=10, θ_{s, i} to N(0, 2).

min Σcᵢxᵢ

s.t. xᵢ≥θᵢi=1, 2, . . . , 100 (Expression 14)

To simplify the description, it is assumed that a non-integer demand and a negative demand are accepted. However, in this example, a probability that θᵢ becomes negative is sufficiently low. Also, here, a demand is predicted on the basis of data in past four days. Here, an estimate value follows θ_{e, i} to N(10, 1) on an assumption of normality.

First, a margin with which a probability that stockout of all items is not caused is 90% is considered. For example, in a case where a margin is determined by a general method, gᵢ(x)=√3, χ⁻¹₁₀₀(0.9)≈18.9 since θ_{e, i}+θ_{s,i} to N(0, 3). That is, it is calculated that it is necessary to have 18.9 more inventory than an estimate value. Note that χ₁₀₀ is a distribution function of a chi-square distribution with 100 degrees of freedom.

It is assumed that the second to hundredth items are fixedly produced for 100 units each. Here, the second to hundredth items almost securely follow a constraint. Thus, substantially, it is only necessary to consider a margin that guarantees an inventory of the first item. That is, on this assumption, the problem is substantially one-dimensional although there are 100 estimation parameters.

A set X corresponding to Step 1 described above corresponds to a situation given by X={x₁≥0, x₂=x₃= . . . =x₁₀₀=100}. Here, in Step 2 described above, Expression 15 exemplified in the following is satisfied.

$$[ Math 3 ]$$

$$\int d {θ}_{e} {min}_{( x ∈ X )} Prob ( {f}_{k} ( {x}_{i} - {θ}_{e} - {θ}_{s} ) + {g}_{k} ( x ) \geq 0 , k = 1 , 2 , … K ) \geq a \approx Prob ( {g}_{1} ( x ) \geq {θ}_{e , 1} + {θ}_{s , 1} ) \geq 0.9 \qquad ( Expression 15 )$$

Thus, g₁(x)=√3 Φ⁻¹(0.9)≈2.2. That is, according to the calculation method of the present exemplary embodiment, the margin is calculated as 2.2. Note that the same margin (18.9) is calculated by the general method even when a fixed value is given since uncertainty of optimization is not considered.

The robust optimization unit 40 adds an estimate value θ^{∧} and the margin 2.2 and performs the above-described processing in Step 3 (robust optimization).

In the above-described example, the description is made without clear statement of a reason for determination of a substantial domain X in order to simplify the description. Next, a detailed example of determining the domain X on the basis of an estimate value will be described. As a detailed example, portfolio optimization is described and it is assumed that a dimension is 100.

Here, in an estimated expected payoff, it is assumed that payoffs of the first to third items are much higher than payoffs of the other items. Here, the substantial domain X is considered to be X={x≥0|x₄=x₅= . . . =x₁₀₀=0}. When optimization is repeated with an estimate value acquired by sampling of an error θₛ and an error θₑ being included, a sample that approximates X is acquired. Even by such a method, the domain X can be automatically determined.

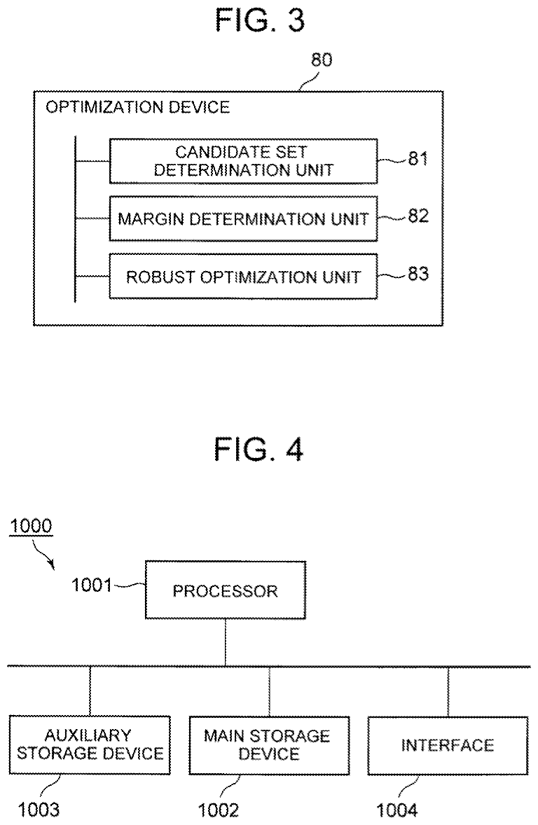

Next, an outline of the present invention will be described. FIG. 3 is a block diagram illustrating an outline of an optimization device according to the present invention. The optimization device according to the present invention is an optimization device 80 (such as optimization device 100) in which an explanatory variable (such as strategy x) used for explanation of a prediction target (such as payoff) becomes an instrumental variable for optimization and which performs the optimization on the basis of a prediction of the prediction target, the device including: a candidate set determination unit 81 (such as candidate set determination unit 20) that determines a set of candidates for a predicted instrumental variable (such as domain); a margin determination unit 82 (such as margin determination unit 30) that determines a margin (such as g) including an estimation error (such as θₑ), which is an error due to the prediction, with a designated probability (such as guarantee probability α) with respect to instrumental variables included in the set; and a robust optimization unit 83 (such as robust optimization unit 40) that performs robust optimization related to the instrumental variables by using the determined margin.

With such a configuration, it is possible to control an excessive guarantee and to calculate an optimal solution in a case where an optimization parameter having uncertainty is given on the basis of a prediction.

Also, the candidate set determination unit 81 may approximate a set of candidates by a sample included in a range of an error from a predicted value (such as system error or estimation error).

Also, the margin determination unit 82 may determine, for all instrumental variable candidates included in the determined set, a margin with which a constraint expression with the margin including an estimation error becomes an upper bound of a true constraint expression.

Also, for all of explanatory variable candidates included in the determined set, the margin determination unit 82 may determine, from a margin candidate set, a minimum margin with which a constraint expression with the margin including an estimation error with a designated probability becomes stricter than a true constraint expression.

More specifically, the margin candidate set may include a margin candidate expressed by a one-dimensional parameter.

Also, the candidate set determination unit 81 may approximate the set of candidates by a sample included in a range of a system error indicating an error due to optimization and the estimation error, and the margin determination unit 82 may determine a margin including the system error and the estimation error with a designated probability.

FIG. 4 is a schematic block diagram illustrating a configuration of a computer according to at least one exemplary embodiment. A computer 1000 includes a CPU 1001, a main storage device 1002, an auxiliary storage device 1003, and an interface 1004.

The above-described optimization device is mounted on the computer 1000. Then, an operation of each processing unit described above is stored in a form of a program (optimization program) in the auxiliary storage device 1003. The CPU 1001 reads the program from the auxiliary storage device 1003, expands the program in the main storage device 1002, and executes the above processing according to the program.

Note that in at least one exemplary embodiment, the auxiliary storage device 1003 is an example of a non-transitory tangible medium. Other examples of a non-transitory tangible medium include a magnetic disk, a magneto-optical disk, a CD-ROM, a DVD-ROM, a semiconductor memory, and the like connected through the interface 1004. Also, in a case where this program is distributed to the computer 1000 via a communication line, the computer 1000 that receives the distribution may expand the program in the main storage device 1002 and execute the above processing.

Also, the program may be to realize a part of the functions described above. Moreover, the program may be a so-called difference file (difference program) that realizes the above-described functions in combination with a different program already stored in the auxiliary storage device 1003.

### REFERENCE SIGNS LIST

10 Input unit
20 Candidate set determination unit
30 Margin determination unit
40 Robust optimization unit
50 Output unit
100 Optimization device

1. An optimization device in which an explanatory variable used for explanation of a prediction target becomes an instrumental variable for optimization and which performs the optimization on the basis of a prediction of the prediction target, the device comprising a hardware processor configured to execute a software code to:
determine a set of candidates for a predicted instrumental variable;
determine a margin including an estimation error, which is an error due to the prediction, with a designated probability with respect to instrumental variables included in the set; and
perform robust optimization related to the instrumental variables by using the determined margin.

2. The optimization device according to claim 1, wherein the hardware processor is configured to execute the software code to
approximate the set of the candidates by a sample included in a range of an error from a predicted value.

3. The optimization device according to claim 1, wherein the hardware processor is configured to execute the software code to
determine, with respect to all of the candidates for the instrumental variable included in the determined set, a margin with which a constraint expression with the margin including the estimation error becomes an upper bound of a true constraint expression.

4. The optimization device according claim 1, wherein
for all explanatory variable candidates included in the determined set, the hardware processor is configured to execute the software code to determine, from a margin candidate set, a minimum margin with which a constraint expression with the margin including the estimation error with the designated probability becomes stricter than a true constraint expression.

5. The optimization device according to claim 4, wherein
the margin candidate set includes a margin candidate expressed by a one-dimensional parameter.

6. The optimization device according to claim 1, wherein the hardware processor is configured to execute the software code to:
approximate the set of the candidates by a sample included in a range of a system error indicating an error due to optimization and the estimation error; and
determine a margin including the system error and the estimation error with a designated probability.

7. An optimization method in which an explanatory variable used for explanation of a prediction target becomes an instrumental variable for optimization and which performs the optimization on the basis of a prediction of the prediction target, the method comprising:
determining a set of candidates for a predicted instrumental variable;
determining a margin including an estimation error, which is an error due to the prediction, with a designated probability with respect to instrumental variables included in the set; and
performing robust optimization related to the instrumental variables by using the determined margin.

8. The optimization method according to claim 7, wherein
the set of the candidates is approximated by a sample included in a range of an error from a predicted value.

9. A non-transitory computer readable information recording medium storing an optimization program applied to a computer in which an explanatory variable used for explanation of a prediction target becomes an instrumental variable for optimization and which performs the optimization on the basis of a prediction of the prediction target, when executed by a processor,
the program performs a method for:
determining a set of candidates for a predicted instrumental variable;
determining a margin including an estimation error, which is an error due to the prediction, with a designated probability with respect to instrumental variables included in the set; and
performing robust optimization related to the instrumental variables by using the determined margin.

10. A non-transitory computer readable information recording medium according to claim 9, wherein
the set of the candidates is approximated by a sample included in a range of an error from a predicted value.
